(19) United States
(12) Patent Application Publication
(10) Pub. No.: US 2013/0148732 A1
(43) Pub. Date: Jun. 13, 2013

(54) VARIABLE BLOCK SIZED HIERARCHICAL MOTION ESTIMATION

(71) Applicants: Jason D. Tanner, Folsom, CA (US); Hong Jiang, El Dorado Hills, CA (US)

(72) Inventors: Jason D. Tanner, Folsom, CA (US); Hong Jiang, El Dorado Hills, CA (US)

(21) Appl. No.: 13/323,949

(22) Filed: Dec. 13, 2011

(51) Int. Cl. H04N 7/26

(52) U.S. Cl. 375/240.16; 375/E07.125

(57) ABSTRACT

Systems, devices and methods are described for performing hierarchical motion estimation by downsampling a current frame to generate a downsampled current frame, specifying a downsampled block in the downsampled current frame, where the downsampled block corresponds to a block of the current frame, and specifying a source block associated with the downsampled block, where the source block is larger than the downsampled block. Motion estimation may then be performed in a downsampled reference frame using the source block.

### BACKGROUND

Video codecs typically employ motion estimation (ME) to improve video compression performance by removing or reducing the temporal redundancy among the video frames. For encoding an input block, traditional ME is performed at an encoder module using a specified search window in at least one reference frame to find a motion vector that minimizes some difference metric such as the Sum of Absolute Differences (SAD) between the input block and the reference block pointed to by the motion vector. The motion vector information may then be transmitted to a decoder module for motion compensation.

Generally, higher coding gains may be achieved during ME by employing larger search windows. However, using larger search windows increases the encoding complexity. Further, when employing hardware acceleration, ME search window size may be limited by on-chip memory size constraints. To address this problem, various advanced video codecs, such as advanced video coding (AVC), scalable video coding (SVC), VP8 and so forth, employ hierarchical motion estimation (HME) to extend the search range while still using a relatively small search window. In HME, a full resolution video frame is downsampled, typically by factors of two, into one or more lower resolution downsample layers. ME is then first undertaken in the downsample layers to reduce encoding complexity in the initial search, and the motion vector resulting from the downsample searches is downsampled to the full resolution or base layer for refinement.

Conventional HME approaches apply the same scaling between layers for the block size employed as the motion search source block. For example, in a conventional HME scheme a 2× downsample layer will employ a 2× downsample source size so that, for example, a 16×16 full resolution source block corresponds to an 8×8 source block in the first downsample layer. However, this source block scaling approach may lead to suboptimal predictors when, for example, local minima are erroneously identified during downsample motion searches.

### BRIEF DESCRIPTION OF THE DRAWINGS

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. In the figures:

FIG. 1 is an illustrative diagram of an example video encoder system;

FIG. 2 illustrates an example hierarchical motion estimation (HME) scheme;

FIG. 3 illustrates example HME schemes;

FIG. 4 is a flow chart illustrating an example HME process;

FIG. 5 is an illustrative diagram of an example system; and

FIG. 6 is an illustrative diagram of an example device, all arranged in accordance with at least some implementations of the present disclosure.

### DETAILED DESCRIPTION

One or more embodiments are now described with reference to the enclosed figures. While specific configurations and arrangements are discussed, it should be understood that this is done for illustrative purposes only. Persons skilled in the relevant art will recognize that other configurations and arrangements may be employed without departing from the spirit and scope of the description. It will be apparent to those skilled in the relevant art that techniques and/or arrangements described herein may also be employed in a variety of other systems and applications other than what is described herein.

While the following description sets forth various implementations that may be manifested in architectures such system-on-a-chip (SoC) architectures for example, implementation of the techniques and/or arrangements described herein are not restricted to particular architectures and/or computing systems and may implemented by any architecture and/or computing system for similar purposes. For instance, various architectures employing, for example, multiple integrated circuit (IC) chips and/or packages, and/or various computing devices and/or consumer electronic (CE) devices such as set top boxes, smart phones, etc., may implement the techniques and/or arrangements described herein. Further, while the following description may set forth numerous specific details such as logic implementations, types and interrelationships of system components, logic partitioning/integration choices, etc., claimed subject matter may be practiced without such specific details. In other instances, some material such as, for example, control structures and full software instruction sequences, may not be shown in detail in order not to obscure the material disclosed herein.

The material disclosed herein may be implemented in hardware, firmware, software, or any combination thereof. The material disclosed herein may also be implemented as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

References in the specification to “one implementation”, “an implementation”, “an example implementation”, etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, it is submitted that it is within the knowledge of one skilled in the art to effect such feature, structure, or characteristic in connection with other implementations whether or not explicitly described herein.

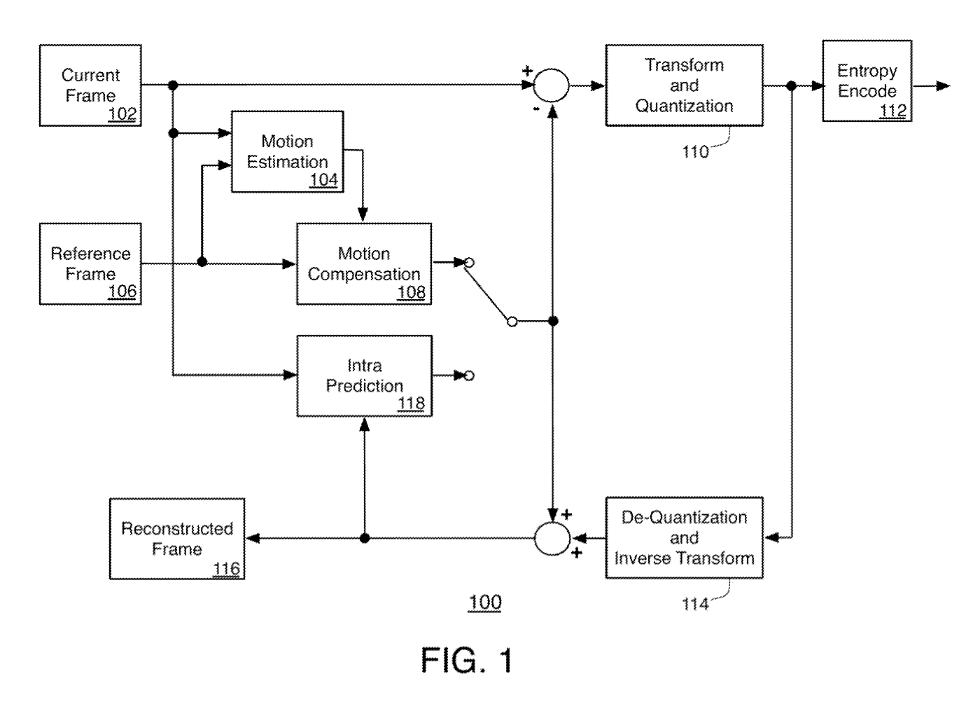

FIG. 1 illustrates an example video encoder system 100 in accordance with the present disclosure. In various implementations, video encoder system 100 may be configured to undertake video compression and/or implement video codecs according to one or more advanced video codec standards, such as, for example, the H.264/AVC standard (see ISO/IEC JTC 1 and ITU-T, H.264/AVC—Advanced video coding for generic audiovisual services,” ITU-T Rec. H.264 and ISO/IEC 14496-10 (MPEG-4 part 10), version 3, 2005)(hereinafter: the “AVC standard”) and extensions thereof including the Scalable Video Coding (SVC) extension (see Joint Draft ITU-T Rec. H.264 and ISO/IEC 14496-10/Amd.3 Scalable video coding, Jul. 5, 2007)(hereinafter the “SVC standard”). Although system 100 and/or other systems, schemes or processes may be described herein in the context of the AVC standard or SVC standard for the purposes of illustration and explanation, the present disclosure is not limited to any particular video encoding standard or specification. For example, in various implementations, encoder system 100 may be configured to undertake video compression and/or implement video codecs according to other advanced video standards such as MPEG-2, VC-1, VP8, and the like.

In various embodiments, a video and/or media processor may implement video encoder system 100. Various components of system 100 may be implemented in software, firmware, and/or hardware and/or any combination thereof. For example, various components of system 100 may be provided, at least in part, by hardware of a computing system-on-a-chip (SoC) such as may be found in a consumer electronics (CE) device or system. In various implementations, video encoder system 100 may be configured to implement the AVC standard and to process a current frame 102 of video data in units of image macroblocks (MBs). As used herein, the term “block” may refer to a MB or to a sub-MB partition of video data.

In encoder system 100, a current video frame 102 may be provided to a motion estimation module 104. When encoder system 100 is operated in inter-prediction mode (as shown), motion estimation module 104 may generate a residual signal in response to current video frame 102 and a reference video frame 106 (e.g., a P frame or B frame). A motion compensation module 108 may then use the reference video frame 106 and the residual signal provided by motion estimation module 104 to generate a predicted frame. The predicted frame may then be subtracted from the current frame 102 and the result provided to a transform and quantization module 110. The block may then be transformed (using a block transform) and quantized to generate a set of quantized transform coefficients which may be reordered and entropy encoded by an entropy encoding module 112 to generate a portion of a compressed bitstream (e.g., a Network Abstraction Layer (NAL) bitstream) provided by video encoder system 100. In various implementations, a bitstream provided by video encoder system 100 may include entropy-encoded coefficients in addition to side information used to decode each block within the macroblock (e.g., prediction modes, quantization parameters, motion vector information, and so forth) and may be provided to other systems and/or devices for transmission or storage.

The output of transform and quantization module 110 may also be provided to a de-quantization and inverse transform module 114. De-quantization and inverse transform module 114 may implement the inverse of the operations undertaken by transform and quantization module 110 and the output of de-quantization and inverse transform module 114 may be combined with the predicted frame to generate a reconstructed frame 116. When encoder system 100 is operated in intra-prediction mode, an intra prediction module 118 may use reconstructed frame 116 to undertake known intra prediction schemes that will not to be described in greater detail herein. Those skilled in the art may recognize that video encoder system 100 may include additional components (e.g., filter modules and so forth) that have not been depicted in FIG. 1 in the interest of clarity.

Various components of system 100 may be implemented in software, firmware, and/or hardware and/or any combination thereof. For example, various components of system 100 may be provided, at least in part, by hardware of a computing system-on-a-chip (SoC) such as may be found in a consumer electronics (CE) system.

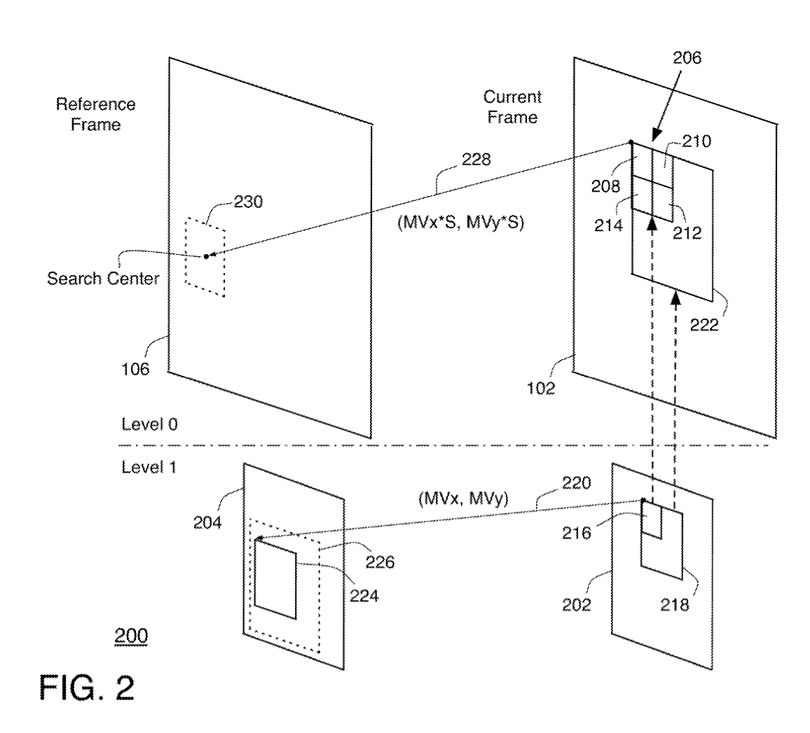

In various embodiments, video encoder system 100 may employ motion estimation module 104 to implement hierarchical motion estimation (HME) schemes. Further, in accordance with the present disclosure, video encoder system 100 may employ motion estimation module 104 to implement HME schemes using variable block sizes. For example, FIG. 2 illustrates an HME scheme 200 in accordance with the present disclosure. By way of non-limiting example, HME scheme 200 will be described herein with reference to example video encoder system 100 of FIG. 1.

In HME scheme 200, prior to performing HME using motion estimation module 104, both current frame 102 and reference frame 106 may first be downscaled or downsampled to generate downsampled current frame 202 and downsampled reference frame 204, respectively, in at least one coarse level (level 1). For example, downsampled frames 202 and 204 may be generated by applying a downscale factor S to the corresponding original frames 102 and 106, where, for example, S may correspond to a factor of two. For instance, in scheme 200, an M×N MB 206 (for example, a 16×16 MB including four 8×8 sub-blocks 208-214) in current frame 102 may be downsampled by a factor of two to generate a corresponding downsampled (M/2)×(N/2) block 216 in downsampled current frame 202 (for example, for a 16×16 MB 206, downsampled block 216 may be an 8×8 block).

While FIG. 2 depicts only two levels in scheme 200, a fine or full resolution level (level 0) and one course level (level 1), scheme 200 may include additional coarse levels such that level 1 corresponds to downscaling frames 102 and 106 by a factor of two, a next coarse level (not shown) corresponds to downscaling frames 202 and 204 by a factor of two, and so forth. The techniques and/or schemes described herein may also apply to any hierarchical motion estimation between or among such additional coarse resolution levels, the present disclosure not being limited to any particular hierarchical motion estimation scheme.

In accordance with the present disclosure, when performing motion estimation using HME scheme 200, motion estimation module 104 may employ a variable-sized motion estimation source block 218, that is larger than downsampled block 216, to determine a coarse level motion vector (MV) 220 having components (MVx, MVy) by performing a motion search in downsampled reference frame 204. For instance, in a non-limiting example, source block 218 may be a M×N block in downsampled current frame 202 (e.g., a 16×16 block oriented as shown with respect to 8×8 block 216) that corresponds to a (M*2)×(N*2) block 222 in current frame 102 (e.g., a 32×32 block encompassing four MBs in frame 102 and oriented as shown with respect to 16×16 MB 206).

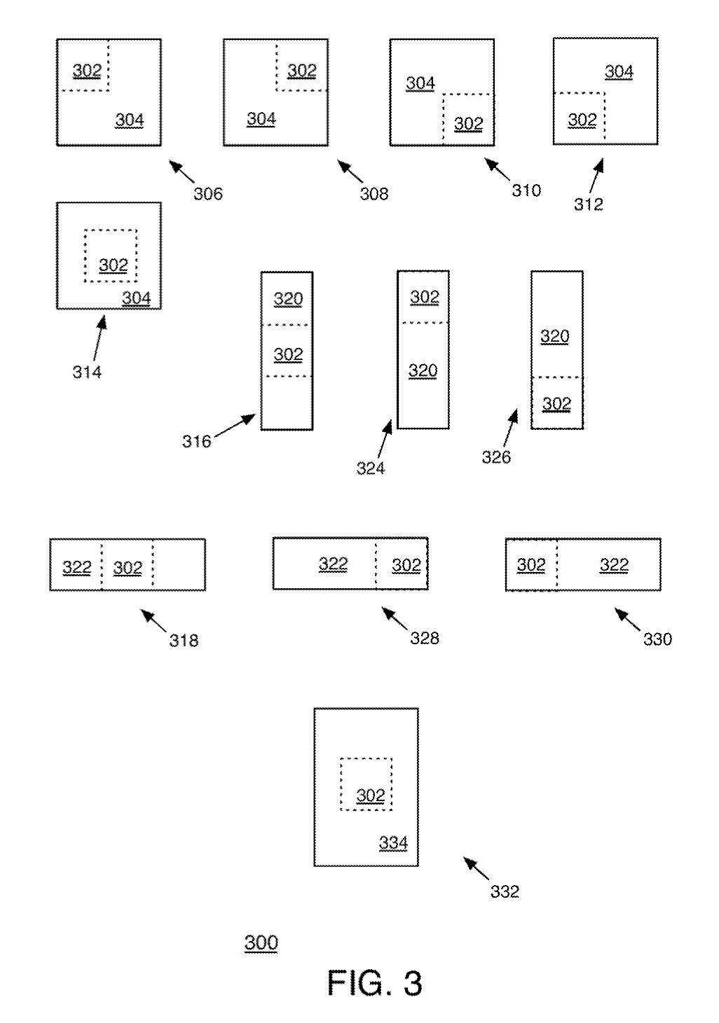

The size, shape and/or orientation of source block 218 with respect to downsampled block 216 as depicted in scheme 200 is only representative of some implementations, and hence, in accordance with the present disclosure, source block 218 may have any size and/or shape and may be variously configured or arranged with respect to downsampled block 216. For instance, FIG. 3 illustrates various example HME schemes 300 in accordance with the present disclosure where a downsampled block 302 is depicted oriented in different ways with respect to larger sample blocks having various sizes and shapes. In scheme 306, block 302 is oriented in an upper-left manner with respect to a square-shaped 2× sample block 304, in an upper-right manner in scheme 308, in a lower-right manner in scheme 310, and in a lower-left manner in scheme 312. In scheme 314, downsampled block 302 is located in the center of sample block 304. In various implementations, in schemes 306-314, downsampled block 302 may be a square-shaped M×N block (e.g., M=N=8) and sample block 304 may be a square-shaped (M*2)×(N*2) block (e.g., M=N=16).

In scheme 316, downsampled block 302 is located in the center of a rectangular-shaped sample block 320 that is vertically oriented with respect to block 302. While, in scheme 318, block 302 is located in the center of a rectangular-shaped sample block 322 that horizontally oriented with respect to block 302. In schemes 324 and 326, block 302 is located off-center upward and off-center downward, respectively, with regard to sample block 320. In schemes 328 and 330, block 302 is located off-center right and off-center left, respectively, with regard to sample block 322, respectively. In various implementations, in schemes 316, 318, 324, 326, 328, and 330, downsampled block 302 may be a square-shaped M×N block (e.g., M=N=8) and sample blocks 320 and 322 may be, respectively, a rectangular-shaped M×(N*3) block (e.g., a 8×32 block), and a (M*3)×N block (e.g., a 32×8 block). In a final example scheme 332, downsampled block 302 is located in the center of a larger sized square-shaped sample block 334. For instance, in the example of scheme 332, downsampled block 302 may be an 8×8 block and sample block 304 may be a 16×32 block, and so forth. Again, schemes 300 are merely example variable block size HME schemes and are not intended to represent an exhaustive list of all possible variable block size HME schemes in accordance with the present disclosure.

Returning to the discussion of FIG. 2, when performing motion estimation on downsampled current frame for M×N MB 206 in accordance with the present disclosure, various blocks 224 having the same size and shape as source block 218 may be searched within a search window 226 of size W×H in downsampled reference frame 204 to identify coarse level MV 220. For instance, source block 218 may be compared to some or all of the possible correspondingly sized regions in search area 226 to identify a best matching sample region in downsampled reference frame 204. For example, for a M×N source block 218, some or all M×N sized regions within search window 226 may be compared to block 218 using any one of various known metrics such as Sum of Absolute Differences (SAD) or the like. Because MBs located adjacent to a target MB (e.g., MBs in block 222 adjacent to MB 206) may have similarly collocated MVs, employing larger source blocks (e.g., block 218) when undertaking HME in a coarse layer in accordance with the present disclosure may result in improved motion vector cohesion and, consequently, in improved compression results and/or fewer false positives in an HME predictor.

After obtaining coarse level MV 220, a fine scale MV 228, having components (MVx*S, MVy*S) may be generated by upsampling coarse level MV 220, and may be used to specify a search center in a corresponding search window 230 of full resolution reference frame 106. In various implementations, search window 230 may be of size (W/2)×(H/2) although the present disclosure is not limited to any particular size, shape or orientation of search window employed.

Refined motion estimation may then be performed within search window 230 to obtain a refined fine level MV (not shown) for block 208 in frame 102. While not depicted in FIG. 2 in the interest of clarity, coarse level MV 220 may also be propagated to each of the remaining sub-blocks 210, 212, and 214 of MB 206 and similar processes may be undertaken to identify refined fine level motion vectors for these sub-blocks as well. Further, if motion estimation at a coarse level (e.g., level 1 of FIG. 2) generates more than one coarse level MV, some or all of the coarse level MVs may be propagated to the next lower level (e.g., level 0) and refined to generate a corresponding number of refined fine level MVs. A best refined fine level MV may then be selected based on, for example, a best SAD value.

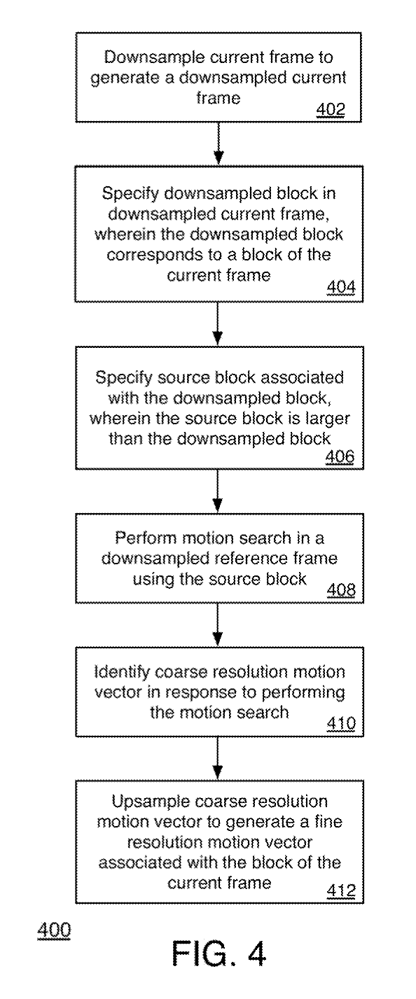

FIG. 4 illustrates a flow diagram of an example process 400 for variable block size HME according to various implementations of the present disclosure. Process 400 may include one or more operations, functions or actions as illustrated by one or more of blocks 402, 404, 406, 408, 410 and 412 of FIG. 4. By way of non-limiting example, process 400 will be described herein with reference to example system 100 of FIG. 1 and example variable block size HME scheme 200 of FIG. 2. In various implementations, a video encoder (e.g., system 100) may undertake process 400 when performing HME in accordance with the present disclosure.

Process 400 may begin at block 402 where a current video frame may be downsampled to generate a downsampled current frame. In various implementations, motion estimation module 104 may undertake block 402 by generating a lower resolution image from current frame 105. For example, referring to scheme 200, Module 104 may downsample current frame 102 to generate frame 202. Module 104 may undertake block 402 using known image downsampling techniques such as mean intensity techniques. For example, when using mean intensity techniques, module 104 may generate a downsampled pixel for each group of four pixels in current frame 102 by determining the mean intensity of the full resolution pixels according to the following expression:

$${g}_{L} ( p , q ) = [ \frac{1}{4} {\sum }_{u = o}^{1} {\sum }_{v = 0}^{1} {g}_{L - 1} ( 2 p + u , 2 q + v ) ] , 1 \leq L \leq 2$$

where gₜ(p,q) is the pixel intensity of pixel (p,q) of the Lth level, and g₀(p,q) denotes pixel (_{A}O of the full resolution current image. However, the present disclosure is not limited to employing mean intensity techniques at block 402 and other known techniques such as subsampling techniques may be employed to generate a downsampled current frame at block 402.

At block 404, a downsampled block may be specified in the downsampled current frame, where the downsampled block corresponds to a block of the current frame. In various implementations, motion estimation module 104 may undertake block 402 by specifying a particular block of the downsampled current frame for coarse level motion estimation processing. For example, referring to scheme 200, module 104 may select block 216 in downsampled current frame 202 for motion estimation processing at level 1, where block 216 corresponds to MB 206 of current frame 102.

At block 406, a source block may be specified that is associated with the downsampled block, where the source block is larger than the downsampled block. In various implementations, motion estimation module 104 may undertake block 406 by specifying a sample block in the downsampled current frame that is larger than and includes the downsampled block. For example, referring to scheme 200, module 104 may designate source block 218 in downsampled current frame 202. The present disclosure is not limited to the particular size, shape and/or orientation of source block designated at block 408 as long as the source block is larger in size than the downsample block specified at block 404.

Process 400 may continue at block 408 where a motion search may be performed in a downsampled reference frame using the source block specified at block 406. In various implementations, motion estimation module 104 may undertake block 408 by comparing the source block specified at block 406 to various blocks having the same size and shape within a search window in downsampled reference frame. For example, referring to scheme 200, module 104 may perform a motion search using known block-based matching algorithms within search window 226 in downsampled reference frame 204. When doing so, module 104 may use known difference metrics such SAD to compare the source block to various blocks in the downsampled reference frame. In various implementations, the motion search of block 408 may be undertaken using hardware acceleration.

At block 410, the results of the motion search may be used to identify a coarse level motion vector, and, at block 412, process 400 may end with the upsampling of the coarse resolution motion vector to generate a fine resolution motion vector associated with the block of the full resolution current frame. In various implementations, motion estimation module 104 may undertake blocks 410 and 412 by using results of the motion search undertaken at block 408 to identify a coarse level MV and then may upsample the coarse level MV to generate a fine resolution motion vector. For example, referring to scheme 200, module 104 may identify coarse level MV 220 having components (MVx, MVy) at block 410 and may then generate fine scale MV 228 at block 412 by multiplying each component of coarse level MV 220 by the downscale factor S.

While implementation of example process 400, as illustrated in FIG. 4, may include the undertaking of all blocks shown in the order illustrated, the present disclosure is not limited in this regard and, in various examples, implementation of process 400 may include the undertaking only a subset of the blocks shown and/or in a different order than illustrated.

In addition, any one or more of the blocks of FIG. 4 may be undertaken in response to instructions provided by one or more computer program products. Such program products may include signal bearing media providing instructions that, when executed by, for example, a processor, may provide the functionality described herein. The computer program products may be provided in any form of computer readable medium. Thus, for example, a processor including one or more processor core(s) may undertake one or more of the blocks shown in FIG. 4 in response to instructions conveyed to the processor by a computer readable medium.

As used in any implementation described herein, the term “module” refers to any combination of software, firmware and/or hardware configured to provide the functionality described herein. The software may be embodied as a software package, code and/or instruction set or instructions, and “hardware”, as used in any implementation described herein, may include, for example, singly or in any combination, hardwired circuitry, programmable circuitry, state machine circuitry, and/or firmware that stores instructions executed by programmable circuitry. The modules may, collectively or individually, be embodied as circuitry that forms part of a larger system, for example, an integrated circuit (IC), system on-chip (SoC), and so forth.

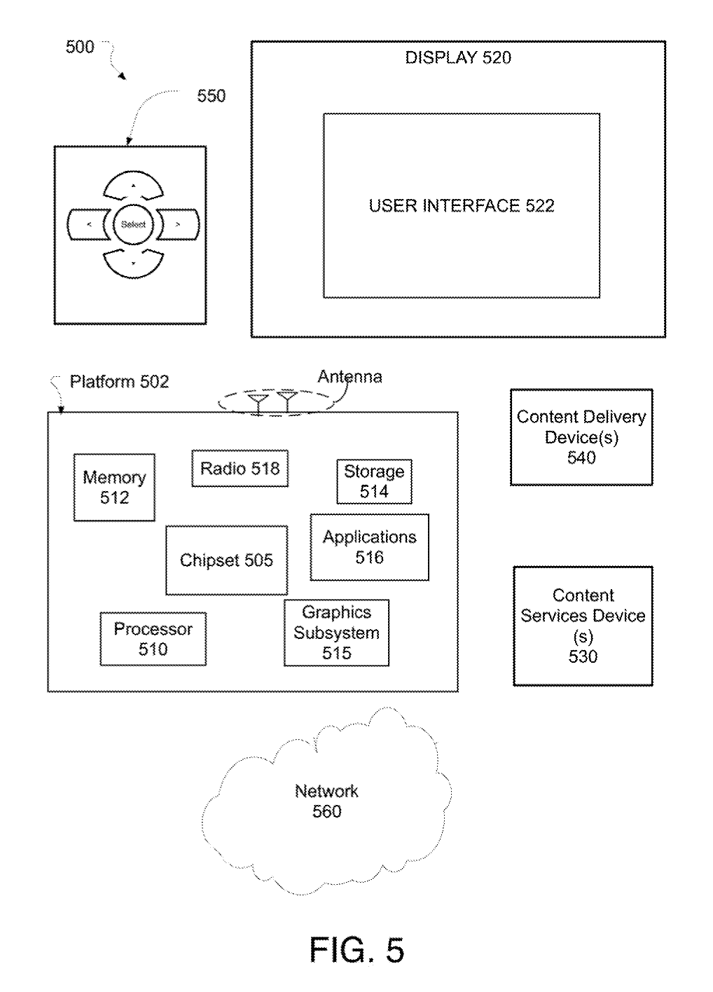

FIG. 5 illustrates an example system 500 in accordance with the present disclosure. In various implementations, system 500 may be a media system although system 500 is not limited to this context. For example, system 500 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

In various implementations, system 500 includes a platform 502 coupled to a display 520. Platform 502 may receive content from a content device such as content services device(s) 530 or content delivery device(s) 540 or other similar content sources. A navigation controller 550 including one or more navigation features may be used to interact with, for example, platform 502 and/or display 520. Each of these components is described in greater detail below.

In various implementations, platform 502 may include any combination of a chipset 505, processor 510, memory 512, storage 514, graphics subsystem 515, applications 516 and/or radio 518. Chipset 505 may provide intercommunication among processor 510, memory 512, storage 514, graphics subsystem 515, applications 516 and/or radio 518. For example, chipset 505 may include a storage adapter (not depicted) capable of providing intercommunication with storage 514.

Processor 510 may be implemented as a Complex Instruction Set Computer (CISC) or Reduced Instruction Set Computer (RISC) processors, x86 instruction set compatible processors, multi-core, or any other microprocessor or central processing unit (CPU). In various implementations, processor 510 may be dual-core processor(s), dual-core mobile processor(s), and so forth.

Memory 512 may be implemented as a volatile memory device such as, but not limited to, a Random Access Memory (RAM), Dynamic Random Access Memory (DRAM), or Static RAM (SRAM).

Storage 514 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In various implementations, storage 514 may include technology to increase the storage performance enhanced protection for valuable digital media when multiple hard drives are included, for example.

Graphics subsystem 515 may perform processing of images such as still or video for display. Graphics subsystem 515 may be a graphics processing unit (GPU) or a visual processing unit (VPU), for example. An analog or digital interface may be used to communicatively couple graphics subsystem 515 and display 520. For example, the interface may be any of a High-Definition Multimedia Interface, DisplayPort, wireless HDMI, and/or wireless HD compliant techniques. Graphics subsystem 515 may be integrated into processor 510 or chipset 505. In some implementations, graphics subsystem 515 may be a stand-alone card communicatively coupled to chipset 505.

The graphics and/or video processing techniques described herein may be implemented in various hardware architectures. For example, graphics and/or video functionality may be integrated within a chipset. Alternatively, a discrete graphics and/or video processor may be used. As still another implementation, the graphics and/or video functions may be provided by a general purpose processor, including a multi-core processor. In a further embodiments, the functions may be implemented in a consumer electronics device.

Radio 518 may include one or more radios capable of transmitting and receiving signals using various suitable wireless communications techniques. Such techniques may involve communications across one or more wireless networks. Example wireless networks include (but are not limited to) wireless local area networks (WLANs), wireless personal area networks (WPANs), wireless metropolitan area network (WMANs), cellular networks, and satellite networks. In communicating across such networks, radio 518 may operate in accordance with one or more applicable standards in any version.

In various implementations, display 520 may include any television type monitor or display. Display 520 may include, for example, a computer display screen, touch screen display, video monitor, television-like device, and/or a television. Display 520 may be digital and/or analog. In various implementations, display 520 may be a holographic display. Also, display 520 may be a transparent surface that may receive a visual projection. Such projections may convey various forms of information, images, and/or objects. For example, such projections may be a visual overlay for a mobile augmented reality (MAR) application. Under the control of one or more software applications 516, platform 502 may display user interface 522 on display 520.

In various implementations, content services device(s) 530 may be hosted by any national, international and/or independent service and thus accessible to platform 502 via the Internet, for example. Content services device(s) 530 may be coupled to platform 502 and/or to display 520. Platform 502 and/or content services device(s) 530 may be coupled to a network 560 to communicate (e.g., send and/or receive) media information to and from network 560. Content delivery device(s) 540 also may be coupled to platform 502 and/or to display 520.

In various implementations, content services device(s) 530 may include a cable television box, personal computer, network, telephone, Internet enabled devices or appliance capable of delivering digital information and/or content, and any other similar device capable of unidirectionally or bidirectionally communicating content between content providers and platform 502 and/display 520, via network 560 or directly. It will be appreciated that the content may be communicated unidirectionally and/or bidirectionally to and from any one of the components in system 500 and a content provider via network 560. Examples of content may include any media information including, for example, video, music, medical and gaming information, and so forth.

Content services device(s) 530 may receive content such as cable television programming including media information, digital information, and/or other content. Examples of content providers may include any cable or satellite television or radio or Internet content providers. The provided examples are not meant to limit implementations in accordance with the present disclosure in any way.

In various implementations, platform 502 may receive control signals from navigation controller 550 having one or more navigation features. The navigation features of controller 550 may be used to interact with user interface 522, for example. In embodiments, navigation controller 550 may be a pointing device that may be a computer hardware component (specifically, a human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of controller 550 may be replicated on a display (e.g., display 520) by movements of a pointer, cursor, focus ring, or other visual indicators displayed on the display. For example, under the control of software applications 516, the navigation features located on navigation controller 550 may be mapped to virtual navigation features displayed on user interface 522, for example. In embodiments, controller 550 may not be a separate component but may be integrated into platform 502 and/or display 520. The present disclosure, however, is not limited to the elements or in the context shown or described herein.

In various implementations, drivers (not shown) may include technology to enable users to instantly turn on and off platform 502 like a television with the touch of a button after initial boot-up, when enabled, for example. Program logic may allow platform 502 to stream content to media adaptors or other content services device(s) 530 or content delivery device(s) 540 even when the platform is turned “off” In addition, chipset 505 may include hardware and/or software support for 5.1 surround sound audio and/or high definition 7.1 surround sound audio, for example. Drivers may include a graphics driver for integrated graphics platforms. In embodiments, the graphics driver may comprise a peripheral component interconnect (PCI) Express graphics card.

In various implementations, any one or more of the components shown in system 500 may be integrated. For example, platform 502 and content services device(s) 530 may be integrated, or platform 502 and content delivery device(s) 540 may be integrated, or platform 502, content services device(s) 530, and content delivery device(s) 540 may be integrated, for example. In various embodiments, platform 502 and display 520 may be an integrated unit. Display 520 and content service device(s) 530 may be integrated, or display 520 and content delivery device(s) 540 may be integrated, for example. These examples are not meant to limit the present disclosure.

In various embodiments, system 500 may be implemented as a wireless system, a wired system, or a combination of both. When implemented as a wireless system, system 500 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 500 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and the like. Examples of wired communications media may include a wire, cable, metal leads, printed circuit board (PCB), backplane, switch fabric, semiconductor material, twisted-pair wire, co-axial cable, fiber optics, and so forth.

Platform 502 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 5.

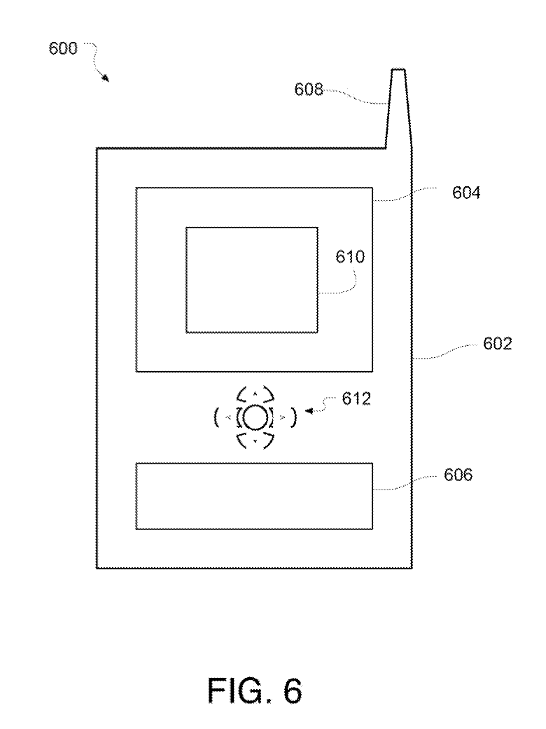

As described above, system 500 may be embodied in varying physical styles or form factors. FIG. 6 illustrates implementations of a small form factor device 600 in which system 500 may be embodied. In embodiments, for example, device 600 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In various embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 6, device 600 may include a housing 602, a display 604, an input/output (I/O) device 606, and an antenna 608. Device 600 also may include navigation features 612. Display 604 may include any suitable display unit for displaying information appropriate for a mobile computing device. I/O device 606 may include any suitable I/O device for entering information into a mobile computing device. Examples for I/O device 606 may include an alphanumeric keyboard, a numeric keypad, a touch pad, input keys, buttons, switches, rocker switches, microphones, speakers, voice recognition device and software, and so forth. Information also may be entered into device 600 by way of microphone (not shown). Such information may be digitized by a voice recognition device (not shown). The embodiments are not limited in this context.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

What is claimed:

1. A computer-implemented method, comprising:
at a video encoder,
downsampling a current frame to generate a downsampled current frame;
specifying a downsampled block in the downsampled current frame, wherein the downsampled block corresponds to a block of the current frame;
specifying a source block associated with the downsampled block, wherein the source block is larger than the downsampled block; and
performing a motion search in a downsampled reference frame using the source block.

2. The method of claim 1, further comprising:
identifying a coarse resolution motion vector in response to performing the motion search.

3. The method of claim 2, further comprising:
upsampling the coarse resolution motion vector to generate a fine resolution motion vector associated with the block of the current frame.

4. The method of claim 1, wherein the block of the current frame comprises a M×N block, wherein the downsampled block comprises a (M12)×(N/2) block in the downsampled current frame, and wherein the source block comprises a M×N block in the downsampled current frame.

5. The method of claim 1, wherein the source block encompasses the downsampled block.

6. The method of claim 1, wherein a size of the source block is at least twice as large as a size of the downsampled block.

7. The method of claim 1, wherein the video encoder is configured to perform hierarchical motion estimation.

8. The method of claim 1, wherein the downsampled block is square-shaped and wherein the source block is rectangular-shaped.

9. An article comprising a computer program product having stored therein instructions that, if executed, result in:
at an video encoder,
downsampling a current frame to generate a downsampled current frame;
specifying a downsampled block in the downsampled current frame, wherein the downsampled block corresponds to a block of the current frame;
specifying a source block associated with the downsampled block, wherein the source block is larger than the downsampled block; and
performing a motion search in a downsampled reference frame using the source block.

10. The article of claim 9, having stored therein instructions that, if executed, result in:
identifying a coarse resolution motion vector in response to performing the motion search.

11. The article of claim 10, having stored therein instructions that, if executed, result in:
upsampling the coarse resolution motion vector to generate a fine resolution motion vector associated with the block of the current frame.

12. The article of claim 9, wherein the block of the current frame comprises a M×N block, wherein the downsampled block comprises a (M/2)×(N/2) block in the downsampled current frame, and wherein the source block comprises a M×N block in the downsampled current frame.

13. The article of claim 9, wherein the source block encompasses the downsampled block.

14. The article of claim 9, wherein a size of the source block is at least twice as large as a size of the downsampled block.

15. The article of claim 9, wherein the video encoder is configured to perform hierarchical motion estimation.

16. The article of claim 9, wherein the downsampled block comprises a square-shaped block and wherein the source block comprises a rectangular-shaped block.

17. A device, comprising:
a processor configured to:
downsample a current frame to generate a downsampled current frame;
specify a downsampled block in the downsampled current frame, wherein the downsampled block corresponds to a block of the current frame;
specify a source block associated with the downsampled block, wherein the source block is larger than the downsampled block; and
perform a motion search in a downsampled reference frame using the source block.

18. The device of claim 17, the processor further configured to:
identify a coarse resolution motion vector in response to performing the motion search.

19. The device of claim 18, the processor further configured to:
upsample the coarse resolution motion vector to generate a fine resolution motion vector associated with the block of the current frame.

20. The device of claim 17, wherein the block of the current frame comprises a M×N block, wherein the downsampled block comprises a (M/2)×(N/2) block in the downsampled current frame, and wherein the source block comprises a M×N block in the downsampled current frame.

21. The device of claim 17, wherein the source block encompasses the downsampled block.

22. The device of claim 17, wherein the size of the source block is at least twice as large as the size of the downsampled block.

23. The device of claim 17, wherein the downsampled block comprises a square-shaped block and wherein the source block comprises a rectangular-shaped block.

24. A system comprising:
a antenna to transmit encoded video data: and
a video encoder, wherein the video encoder is communicatively coupled to the antenna and wherein the video encoder is to generate the encoded video data by, at least in part:
downsampling a current frame to generate a downsampled current frame;
specifying a downsampled block in the downsampled current frame, wherein the downsampled block corresponds to a block of the current frame;
specifying a source block associated with the downsampled block, wherein the source block is larger than the downsampled block; and
performing a motion search in a downsampled reference frame using the source block.

25. The system of claim 24, having stored therein instructions that, if executed, result in:
identifying a coarse resolution motion vector in response to performing the motion search.

26. The system of claim 25, having stored therein instructions that, if executed, result in:
upsampling the coarse resolution motion vector to generate a fine resolution motion vector associated with the block of the current frame.

27. The system of claim 24, wherein the block of the current frame comprises a M×N block, wherein the downsampled block comprises a (M/2)×(N/2) block in the downsampled current frame, and wherein the source block comprises a M×N block in the downsampled current frame.

28. The system of claim 24, wherein the source block encompasses the downsampled block.

29. The system of claim 24, wherein the downsampled block comprises a square-shaped block and wherein the source block comprises a rectangular-shaped block.
